(19) United States
(12) Patent Application Publication
(10) Pub. No.: US 2026/0117402 A1
(43) Pub. Date: Apr. 30, 2026

(54) ELECTROLYTIC SYSTEMS COMPRISING GAS DIFFUSION ANODES AND METHODS OF OPERATING THEREOF

(71) Applicant: AEPNUS TECHNOLOGY INC., EMERYVILLE, CA (US)

(72) Inventors: Bilen AKÜZÜM, Emeryville, CA (US); Lukas HACKL, Emeryville, CA (US); Hans-Joachim KOHNKE, Emeryville, CA (US); Joachim HELMKE, Emeryville, CA (US)

(73) Assignee: AEPNUS TECHNOLOGY INC., EMERYVILLE, CA (US)

(21) Appl. No.: 19/474,578

(22) PCT Filed: Apr. 12, 2024
(86) PCT No.: PCT/US2024/024322

§ 371 Date: Oct. 10, 2025

Related U.S. Application Data
(60) Provisional application No. 63/495,856, filed on Apr. 13, 2023.

(51) Int. Cl. C25B 11/032; C25B 1/16; C25B 9/23; C25B 11/052; C25B 11/061; C25B 11/095

(52) U.S. Cl. CPC C25B 11/032; C25B 9/23; C25B 11/052; C25B 11/061; C25B 11/095; C25B 1/16

(57) ABSTRACT

Described herein are gas diffusion anodes, electrolytic systems comprising such anodes, as well as methods of using such systems. A gas diffusion anode comprises a current collector, an anode porous base, an anode catalyst layer, and an anode-liquid interfacing layer. During the operation, the anode gas chamber receives hydrogen gas, which flows through the current collector into the anode porous base. The anode porous base provides uniform distribution of the hydrogen gas as well as uniform current density. The anode catalyst layer converts the hydrogen gas into protons and returns electrons, through the anode porous base, to the current collector. Protons are transported by the anode-liquid interfacing layer to an anolyte. This layer also blocks the anolyte from contacting the anode catalyst layer. The anode porous base, anode catalyst layer, and anode-liquid interfacing layer help to prevent the migration of the anolyte into an anode gas chamber.

### CROSS-REFERENCE TO RELATED APPLICATIONS

The present application claims the benefit of priority of co-pending U.S. Provisional Ser. No. 63/495,856 , which was filed Apr. 13, 2023, the content of which is incorporated herein by reference in its entirety.

### TECHNICAL FIELD

The present application relates to electrochemical systems, More particularly, it relates to gas diffusion anodes, electrolytic systems comprising the same and methods thereof.

### BACKGROUND

Electrolytic cells use external electrical energy sources to drive various chemical reactions. For example, such cells or, more generally, electrolytic systems can be used for converting metal salts (e.g., provided as a part of brines during mineral extraction) into metal hydroxides (e.g., used for producing lithium and sodium). Electrolytic cells/systems can be also referred to as electrolyzers, electrolysis cells/systems, and electrochemical cells/systems. Such cells/systems comprise two electrodes (i.e., an anode/positively charged electrode and a cathode/negatively charged electrode) that are submerged in an electrolyte solution with a voltage applied between the electrodes to drive an electrochemical reaction.

A conventional electrolytic /stem/ process for metal salt conversions splits (1) water molecules into protons and oxygen gas at the anode and (2) into hydroxide ions and hydrogen gas at the cathode. In such systems, anode materials must be chosen to be stable in acidic operating environments, while cathode materials must be stable in basic operating environments. Cathodes in such systems can be made from stainless steel or nickel. Anodes require coatings of conductive metal oxides made out of metals such as iridium-oxide or ruthenium oxide coatings, which act as a catalyst for water or chloride oxidation respectively and hence lower power consumption.

### SUMMARY

Described herein are gas diffusion anodes, electrolytic systems comprising such gas diffusion anodes, as well as methods of using such systems for converting metal salts into hydroxides. A gas diffusion anode comprises an anode gas chamber, a current collector, an anode porous base, an anode catalyst layer, and an anode-liquid interfacing layer. During the operation, the anode gas chamber receives hydrogen gas, which flows through the current collector into the anode porous base. The anode porous base provides uniform distribution of the hydrogen gas as well as uniform current density. The anode catalyst layer converts the hydrogen gas into protons and returns electrons, through the anode porous base, to the current collector. Protons are transported by the anode-liquid interfacing layer to an anolyte. The anode porous base, anode catalyst layer, and anode-liquid interfacing layer help to prevent the migration of the anolyte into the anode gas chamber.

Accordingly, the present application includes a gas diffusion anode, the gas diffusion anode comprising: a current collector, comprising a conductive mesh; an anode porous base positioned adjacent to the current collector, wherein the anode porous base comprises a porous electronically-conductive structure; an anode catalyst layer positioned adjacent to the anode porous base, the anode catalyst layer comprising a conductive filler, a binder, and a catalyst, has an average porosity different than that of the anode porous base, and is positioned adjacent to the anode porous base such that the anode catalyst layer is positioned between the anode porous base and the anode-liquid interfacing layer; and an anode-liquid interfacing layer positioned adjacent to the anode catalyst layer such that the anode catalyst layer is positioned between the anode porous base and the anode-liquid interfacing layer; the anode-liquid interfacing layer comprising a porous polymer base and an ionomer coating configured to conduct protons through the anode-liquid interfacing layer.

The present application also includes a gas diffusion anode for use in an electrochemical cell, the gas diffusion anode comprising: an anode gas chamber; a current collector positioned adjacent to the anode gas chamber such that the current collector is positioned between the anode gas chamber and the anode porous base, the current collector comprising a conductive mesh; an anode porous base is positioned adjacent to the current collector, wherein the anode porous base comprises a porous electronically-conductive structure; an anode catalyst layer positioned adjacent to the anode porous base, the anode catalyst layer comprising a conductive filler, a binder, and a catalyst, has an average porosity different than that of the anode porous base, and is positioned adjacent to the anode porous base such that the anode catalyst layer is positioned between the anode porous base and the anode-liquid interfacing layer; and an anode-liquid interfacing layer positioned adjacent to the anode catalyst layer such that the anode catalyst layer is positioned between the anode porous base and the anode-liquid interfacing layer; the anode-liquid interfacing layer comprising a porous polymer base and an ionomer coating configured to conduct protons through the anode-liquid interfacing layer.

Also provided is an electrochemical system comprising: a cathode, the gas diffusion anode of the present application, and a cell membrane positioned between the cathode and gas diffusion anode, wherein the cathode and the cell membrane define a catholyte channel therebetween, and the gas diffusion anode and the cell membrane define an anolyte channel therebetween.

The present application further includes a method of operating an electrochemical system of the present application, the method comprising: flowing a catholyte into the catholyte channel of the electrochemical system, wherein the catholyte comprises at least water; flowing an anolyte into the anolyte channel of the electrochemical system, wherein the anolyte comprises a metal salt in the form of metal cations and anions; flowing hydrogen gas into the gas diffusion anode of the electrochemical system; and applying a voltage between the cathode and the gas diffusion anode thereby converting the hydrogen gas into protons, being released into the anolyte, and driving the metal cations across the cell membrane of the electrolytic cell from the anolyte to the catholyte.

These and other embodiments are described further below with reference to the figures.

### BRIEF DESCRIPTION OF THE DRAWINGS

The included drawings are for illustrative purposes and serve only to provide examples of possible structures and operations for the disclosed inventive systems, apparatus, and methods. These drawings in no way limit any changes in form and detail that may be made by one skilled in the art without departing from the spirit and scope of the disclosed implementations.

FIG. 1A is one example of an electrolytic cell comprising a conventional solid anode, the system being used for converting metal salts into metal hydroxides.

FIG. 1B is another example of an electrolytic cell comprising a gas diffusion anode, the system also being used for converting metal salts into hydroxides.

FIG. 1C is a plot comparing electrode potentials in the electrolytic cells of FIGS. 1A and 1B.

FIG. 2A is a schematic cross-sectional view of an electrolytic system comprising a gas diffusion anode as well as other components, in accordance with some examples.

FIG. 2B is a schematic cross-sectional view of an electrolytic system comprising a gas diffusion anode and a feedstock channel in addition to the anolyte and catholyte channels as well as other components, in accordance with some examples.

FIG. 2C is a block diagram of a catholyte showing various catholyte components, in accordance with some examples.

FIG. 2D is a block diagram of an anolyte showing various anolyte components, in accordance with some examples.

FIG. 2E is a block diagram of a feedstock showing various feedstock components, in accordance with some examples.

FIG. 2F is a schematic flowchart of an electrolytic system illustrating various connections and flow streams, in accordance with some examples.

FIG. 3A is a schematic cross-sectional view of a gas diffusion anode illustrating various components of this anode, in accordance with some examples.

FIG. 3B is a schematic cross-sectional view of another example of a gas diffusion anode, which comprises an anolyte-falling film structure.

FIG. 3C is a schematic block diagram of the anode catalyst layer in a gas diffusion anode, illustrating various components of this anode catalyst layer, in accordance with some examples.

FIG. 3D is a plot of binder concentration and pore sizes in the anode porous base across the thickness, in accordance with some examples.

FIG. 3E is a plot of pore sizes in the anode porous base along the height, in accordance with some examples.

FIG. 3F is a plot of two pressure profiles along the height corresponding to different cell examples.

FIG. 4 is a process flowchart corresponding to a method of forming a gas diffusion anode, in accordance with some examples.

FIG. 5 is a process flowchart corresponding to a method of operating an electrolytic system comprising a gas diffusion anode, in accordance with some examples.

FIG. 6 is a schematic representation of an electrolytic cell comprising the gas diffusion anode of the present application, according to exemplary embodiments.

FIG. 7 is a plot showing the voltage performance of the gas diffusion anode according to exemplary embodiments of the present application compared to a commercially available mixed metal oxide (MMO) anode.

FIG. 8 a plot showing the specific energy consumption of the gas diffusion anode according to exemplary embodiments of the present application compared to a commercially available mixed metal oxide (MMO) anode.

FIG. 9 a plot showing the current efficiency of the gas diffusion anode according to exemplary embodiments of the present application compared to a commercially available mixed metal oxide (MMO) anode.

FIG. 10 a plot showing the stability of the electrodes including the gas diffusion anode according to exemplary embodiments of the present application over 400 hours of operation.

### DETAILED DESCRIPTION

### Definitions

Unless otherwise indicated, the definitions and embodiments described in this and other sections are intended to be applicable to all embodiments and aspects of the present application herein described for which they are suitable as would be understood by a person skilled in the art.

As used in this application and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The term “consisting” and its derivatives as used herein are intended to be closed terms that specify the presence of the stated features, elements, components, groups, integers, and/or steps, and also exclude the presence of other unstated features, elements, components, groups, integers and/or steps.

The term “consisting essentially of”, as used herein, is intended to specify the presence of the stated features, elements, components, groups, integers, and/or steps as well as those that do not materially affect the basic and novel characteristic(s) of these features, elements, components, groups, integers, and/or steps.

The terms “about”, “substantially” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies or unless the context suggests otherwise to a person skilled in the art.

As used in the present application, the singular forms “a”, “an” and “the” include plural references unless the content clearly dictates otherwise. For example, an embodiment including “a component” should be understood to present certain aspects with one component, or two or more additional components.

In embodiments comprising an “additional” or “second” component or effect, the second component as used herein is different from the other components or first component. A “third” component is different from the other, first, and second components, and further enumerated or “additional” components are similarly different.

The term “and/or” as used herein means that the listed items are present, or used, individually or in combination. In effect, this term means that “at least one of” or “one or more” of the listed items is used or present.

The term “suitable” as used herein means that the selection of the particular component or conditions would depend on the specific synthetic manipulation to be performed, the identity of the component to be transformed and/or the specific use for the component, but the selection would be well within the skill of a person trained in the art.

Battery and other industries are experiencing growing demand for various materials used in manufacturing. Conventional methods of producing these materials can be energy intensive, require high capital expenditures, and produce various byproducts that need to be further utilized. For example, one of the main waste products during the manufacturing of lithium-ion battery materials is sodium sulfate (Na₂SO₄). While sodium sulfate is used for the manufacturing of detergents, glass, and lubrication industries, the global market size for this material is currently around 30 MT/year with no significant demand increases expected in the future. In comparison, a single large-scale battery cathode manufacturing plant can produce up to 250,000/t of anhydrous sodium sulfate (as a byproduct) per year. The environmental concerns around the proper disposal of such high volumes of sodium sulfate are significant. At the same time, battery material manufacturing processes require various chemicals, such as sodium hydroxide (NaOH) and sulfuric acid (H₂SO₄).

Sodium sulfate (Na₂SO₄) can be converted or, more specifically, electrochemically split into sodium hydroxide (NaOH) and sulfuric acid (H₂SO₄). One conventional approach involves a bi-polar membrane electrodialysis (BPED) process using a 4-compartment electrolytic cell with three membranes: (1) an anion exchange membrane (AEM), (2) a cation exchange membrane (CEM), and a bi-polar membrane (BPM). The energy efficiency of such systems is around 1500-2500 kWh/t of sodium hydroxide (NaOH) produced. However, BPED cells operate at relatively low current densities (\tilde{ }1000 A/m²) requiring many large electrodialysis stacks thereby driving up the capital costs. This process can produce only diluted acid and base solutions (e.g., up about 4-10 wt %). Furthermore, AEMs limit the operating temperature of the BPED systems to around 40-50° C. Such low temperatures require more energy for post-processing/solution concentration. Finally, BPM membranes are prone to degradation when various impurities (e.g., chlorides and heavy metals) are present in the feedstock.

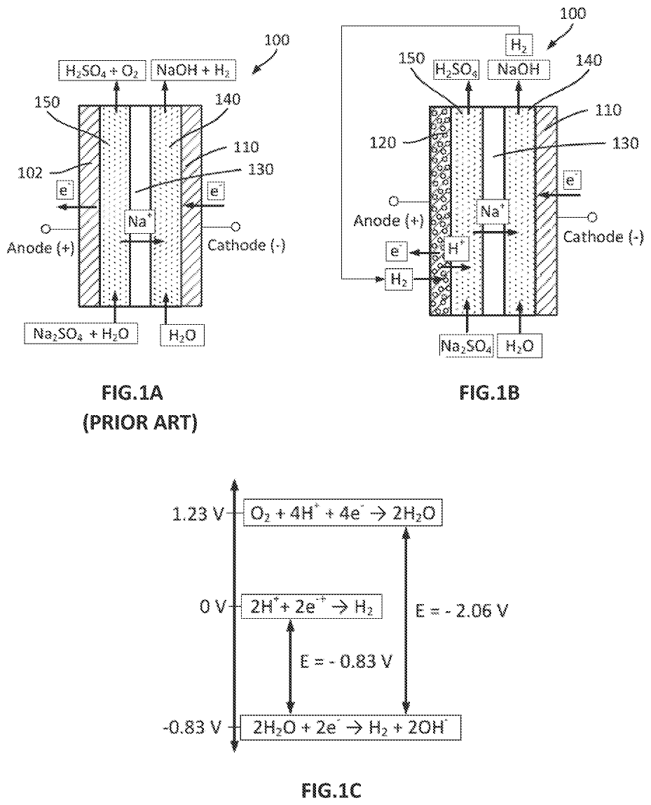

Another conventional approach (shown in FIG. 1A) uses a two-compartment type of electrolytic cell 100, which comprises anode 102 (e.g., coated with iridium oxide (IrO₂)) and cathode 110 (e.g., formed from nickel or stainless steel). This example of a cell may be referred to as a DSA-O2 cell. Cell membrane 130 can be a single cation exchange membrane (CEM) and can provide higher current densities (about 3000-4000 A/m²) with highly concentrated acid and base steams (e.g., up to 20% by weight). Water in catholyte 140 is split/reduced into hydrogen gas (H₂) and hydroxide anions (OH⁻). Water in anolyte 150 is split/oxidized into oxygen gas (O₂) and protons (H⁺). Anolyte 150 also comprises a feedstock (shown as sodium sulfate (Na₂SO₄) in this example), which comprises cations (e.g., Na⁺). These cations are displaced by the protons (H⁺) through cell membrane 130 into catholyte 140. As such, at the outlet of electrolytic cell 100, catholyte 140 includes sodium hydroxide (NaOH) and hydrogen gas (H₂), while anolyte 150 includes sulfuric acid (H₂SO₄) and oxygen gas (O₂). The total theoretical voltage for this electrochemical cell (including anode and cathode) is 2.06V (as shown in FIG. 1C), which is quite high and requires substantial energy expenditures. Furthermore, the acid environment of anode 102 the basic environment of cathode 110 can be damaging to these electrodes, in particular to anode 102.

Various problems listed above are addressed by electrolytic cell 100, which comprises gas diffusion anode 120 described herein. Electrolytic cell 100 can be a part of a 2-channel system (with a single membrane) or a 3-channel system (with two membranes) . One example of such electrolytic cell 100 is shown in FIG. 1B, illustrating gas diffusion anode 120 in addition to cathode 110 and cell membrane 130. Hydrogen gas (H₂) is fed through gas diffusion anode 120, which produces protons (H⁺) released into anolyte 150. The feedstock (e.g., sodium sulfate (Na₂SO₄)) is introduced into anolyte 150. For purposes of this disclosure, the terms “feedstock” and “metal salt” are used interchangeably. Furthermore, it should be noted that the feedstock/metal salt can be introduced into anolyte 150 (in a 2-channel system) or feedstock solution 160 (in a 3-channel system). Referring to the 2-channel example in FIG. 1B, sodium cations (Na⁺) are displaced from anolyte 150 by the protons introduced from gas diffusion anode 120. Specifically, these sodium cations (Na⁺) pass through cell membrane 130 into catholyte 140. The water in catholyte 140 is split/reduced into hydrogen gas (H₂) and hydroxide anions (OH) . As such, at the outlet of electrolytic cell 100, catholyte 140 includes sodium hydroxide (NaOH) and hydrogen gas (H₂), while anolyte 150 includes sulfuric acid (H₂SO₄).

Unlike the reference cell described above with reference to FIG. 1A, there is no generated oxygen gas (O₂) in anolyte 150 of electrolytic cell 100, which comprises gas diffusion anode 120. Furthermore, the total theoretical voltage for this electrochemical cell (including anode and cathode) is 0.83V (as shown in FIG. 1C), which is significantly lower than that of the reference cell thereby reducing energy expenditures. Furthermore, these gas-diffusion-anode cells can be operated at a temperature of 75° C. or higher, which is about 50% higher than that of the reference cell. A higher temperature helps with the post-processing increase of various concentrations (e.g., the metal hydroxide concentration). In addition, higher temperature operation also improves the kinetics of the electrolysis process, lowering the necessary operating potential. Roughly between 0.1-0.3V can be reduced from the operating voltage for every 10° C. increase in operating temperature.

One challenge of gas-diffusion-anode cells is controlling/limiting/blocking the anolyte migration through the gas diffusion anodes of such cells. Various features of gas diffusion anodes are used to eliminate or at least reduce this potential anolyte migration, which can be also referred to as anolyte flooding (referring to the event when significant amounts of anolyte pass through the anode and impede the anode's operation). Some of these features include porosity and hydrophobicity of various layers as well as the distribution of these characteristics across the components'thicknesses and/or components'heights.

Furthermore, uniform hydrogen distribution to catalyst sites is important to ensure efficient cell operation and is provided by various features of the gas diffusion anodes. For example, a gas diffusion anode comprises an anode gas chamber, a current collector, an anode porous base, an anode catalyst layer, and an anode-liquid interfacing layer. During the operation, the anode gas chamber receives hydrogen gas, which flows through the current collector into the anode porous base. The anode porous base provides uniform distribution of the hydrogen gas as well as uniform current density. The anode catalyst layer converts the hydrogen gas into protons and returns electrons, through the anode porous base, to the current collector. Protons are transported by the anode-liquid interfacing layer to an anolyte. The anode porous base, anode catalyst layer, and anode-liquid interfacing layer help to prevent the migration of the anolyte into the anode gas chamber.

It should be noted that due to the facile reaction kinetics of the hydrogen oxidation reaction, small amounts of platinum catalysts (0.2-1 mg/cm² or 0.05-2 mg/cm²) can achieve high current densities of up to 10 kA/m². Further, hydrogen gas is produced on the cathode at an equal stoichiometric ratio.

Accordingly, the present application includes a gas diffusion anode, the gas diffusion anode comprising: a current collector, comprising a conductive mesh; an anode porous base positioned adjacent to the current collector, wherein the anode porous base comprises a porous electronically-conductive structure; an anode catalyst layer positioned adjacent to the anode porous base, the anode catalyst layer comprising a conductive filler, a binder, and a catalyst, has an average porosity different than that of the anode porous base, and is positioned adjacent to the anode porous base such that the anode catalyst layer is positioned between the anode porous base and the anode-liquid interfacing layer; and an anode-liquid interfacing layer positioned adjacent to the anode catalyst layer such that the anode catalyst layer is positioned between the anode porous base and the anode-liquid interfacing layer; the anode-liquid interfacing layer comprising a porous polymer base and an ionomer coating configured to conduct protons through the anode-liquid interfacing layer.

The present application also includes a gas diffusion anode for use in an electrochemical cell, the gas diffusion anode comprising: an anode gas chamber; a current collector positioned adjacent to the anode gas chamber such that the current collector is positioned between the anode gas chamber and the anode porous base, the current collector comprising a conductive mesh; an anode porous base is positioned adjacent to the current collector, wherein the anode porous base comprises a porous electronically-conductive structure; an anode catalyst layer positioned adjacent to the anode porous base, the anode catalyst layer comprising a conductive filler, a binder, and a catalyst, has an average porosity different than that of the anode porous base, and is positioned adjacent to the anode porous base such that the anode catalyst layer is positioned between the anode porous base and the anode-liquid interfacing layer; and an anode-liquid interfacing layer positioned adjacent to the anode catalyst layer such that the anode catalyst layer is positioned between the anode porous base and the anode-liquid interfacing layer; the anode-liquid interfacing layer comprising a porous polymer base and an ionomer coating configured to conduct protons through the anode-liquid interfacing layer.

In some embodiments, wherein the anode-liquid interfacing layer comprises an exposed anode liquid-side outer surface.

In some embodiments, the gas diffusion anode further comprises an anolyte falling-film structure positioned adjacent to the anode-liquid interfacing layer such that the anode-liquid interfacing layer is positioned between the anode catalyst layer and the anolyte falling-film structure. In some embodiments, the falling-film structure is a piece of very highly open structure 3D-mesh that regulates the flow of the anolyte. In other words, a skilled person would understand that falling-film refers to controlled flow. In some embodiments, the anode-liquid interfacing layer comprises 3D geometries directly printed on the anode-liquid interfacing layer.

In some embodiments, the conductive mesh is formed from metal or metal alloys. In some embodiments, the conductive mesh is formed from titanium, high-alloy stainless steel (e.g. 2205, 2507, 904L, alloy 28), stainless steel (such as 316L, 304L), hastelloy alloys (B, B-2, C, and D series), high-Si iron, lead, tantalum, zirconium, or titanium carbide. In some embodiments, the conductive mesh is formed from conductive carbon substrate such as woven carbon fibers, felt, foam or the like.

In some embodiments, the conductive mesh is coated with conductive material such as graphite powder, carbon black, mesocarbon microbeads, activated carbon, carbon nanotubes, titanium carbide, diamond like carbon, silicon carbide, titanium carbide, gold, platinum, iridium or combinations thereof. In some embodiments, the conductive mesh is coated with conductive carbon material, i.e. a material comprising carbon. In some embodiments, the conductive carbon material is graphene, carbon black, carbon nanotubes, diamond like carbon, silicon carbide, titanium carbide, or combinations thereof.

In some embodiments, the conductive mesh has an average mesh opening size of about 0.1 mm to about 5 mm. In some embodiments, the conductive mesh has an average mesh opening size of about 1 mm to about 2 mm. In some embodiments, the conductive mesh has an average mesh opening size of about 1.2 mm to about 1.6 mm. In some embodiments, the conductive mesh has an average mesh opening size of about 0.5 mm to about 1 mm. In some embodiments, the conductive mesh has an average mesh opening size of about 2 mm to about 3.6 mm. In some embodiments, the conductive mesh has an average mesh opening size of about 3.6 mm to about 5 mm. In some embodiments, the conductive mesh has an average mesh opening size of about 0.5 mm to about 2.5 mm, or about 0.5 mm to about 1.5 mm, or about 0.1 mm to about 0.25 mm.

In some embodiments, a wire forming the conductive mesh has a thickness of about 0.1 mm to about 4 mm. In some embodiments, a wire forming the conductive mesh has a thickness of about 0.1 mm to about 0.25 mm. In some embodiments, a wire forming the conductive mesh has a thickness of about 0.25 mm to about 0.5 mm. In some embodiments, a wire forming the conductive mesh has a thickness of about 0.5 mm to about 1 mm. In some embodiments, a wire forming the conductive mesh has a thickness of about 1 mm to about 2 mm. In some embodiments, a wire forming the conductive mesh has a thickness of about 2 mm to about 4 mm.

In some embodiments, the anode porous base has a variable porosity across the thickness and/or across the cell height of the anode porous base. In some embodiments, the variable porosity ranges from about 20% to about 90%. In some embodiments, the highest porosity is from about 55% to about 90%, or from about 65% to about 85%, to about 75% to about 90%. In some embodiments, the lowest porosity is from about 20% to about 35%, or from about 35% to about 55%, or from about 20% to about 45%.

In some embodiments, the anode porous base has a thickness of about 100 μm to about 700 μm. In some embodiments, the anode porous base has a thickness of about 200 μm to about 400 μm. In some embodiments, the anode porous base has a thickness of about 250 μm to about 350 μm. In some embodiments, the anode porous base has a thickness of about 350 μm to about 700 μm.

In some embodiments, the anode porous base is formed of a polymer and a carbon material. In some embodiments, the anode porous base is formed of about 20 wt. % to about 60wt. % of the polymer and about 40% wt. to about 80wt. % of the carbon material. In some embodiments, the anode porous base is formed of about 25 wt. % to about 55wt. % of the polymer and about 45% wt. to about 75wt. % of the carbon material. In some embodiments, the anode porous base is Formed of about 30 wt. % to about 50wt. % of the polymer and about 50% wt. to about 70wt. % of the carbon material.

In some embodiments, the polymer is polytetrafluoroethylene (PTFE), such as PTFE wax, PTFE fibers, or PTFE paste, polyvinylene fluoride (PVDF), or a combination thereof. In some embodiments, the carbon material is graphite powder, carbon black, mesocarbon microbeads, activated carbon, carbon nanotubes, graphene, titanium carbide or a combination thereof.

In some embodiments, the anode porous base is configured to be a) electrically conductive, b) permeable to gas, specifically hydrogen, and c) impermeable to electrolyte.

In some embodiments, the anode catalyst layer further comprises a structural conductive support. In some embodiments, the conductive support is made of carbon particles configured to receive precipitates of precious metal catalysts.

In some embodiments, the catalyst is a material with catalytic properties for the oxidation of hydrogen, including but not limited to platinum on carbon (Pt—C), platinum black, iridium oxide, nickel, palladium, rhodium, ruthenium, oxides of titanium with the general formula Ti₍ₙ₎O₍₂ₙ₋₋₁₎, or a combination thereof.

In some embodiments, the conductive filler is graphite powder, carbon black, mesocarbon microbeads, activated carbon, graphene, carbon black, carbon nanotubes, diamond like carbon, silicon carbide, titanium carbide or a combination thereof.

In some embodiments, the binder is polyvinylene fluoride (PVDF), polytetrafluoroethylene(PTFE), PTFE wax, PTFE fibers, PTFE paste or a combination thereof.

In some embodiments, the anode catalyst layer has a thickness of about 1 μm to about 75 μm. In some embodiments, the anode catalyst layer has a thickness of about 2 μm to about 25 μm. In some embodiments, the anode catalyst layer has a thickness of about 10 μm to about 45 μm. In some embodiments, the anode catalyst layer has a thickness of about 35 μm to about 75 μm.

In some embodiments, the anode-liquid interfacing layer has a thickness of about 100 μm to about 600 μm. In some embodiments, the anode-liquid interfacing layer has a thickness of about 200 μm to about 350 μm. In some embodiments, the anode-liquid interfacing layer has a thickness of about 220 μm to about 320 μm. In some embodiments, the anode-liquid interfacing layer has a thickness of about 250 μm to about 300 μm. In some embodiments, the anode-liquid interfacing layer has a thickness of about 350 μm to about 500 μm. In some embodiments, the anode-liquid interfacing layer has a thickness of about 450 μm to about 600 μm.

In some embodiments, the porous polymer base comprises polyethylene (PE), polypropylene (PP), PTFE, PVDF, PBI (polybenzimidazole), sulfonated tetrafluoroethylene based fluoropolymer-copolymer (Nafion™) or a combination thereof.

In some embodiments, the ionomer coating comprises perfluoro-sulfonic acid (PFSA), sulfonated tetrafluoroethylene based fluoropolymer-copolymer (Nafion™), sulfuric acid doped s-PBI (polybenzimidazole) polymer, sulfonated s-PBI (polybenzimidazole) polymer or combinations thereof.

In some embodiments, the ionomer coating has a thickness of about 1 μm to about 100 μm. In some embodiments, the ionomer coating has a thickness of about 2 μm to about 15 μm. In some embodiments, the ionomer coating has a thickness of about 10 μm to about 50 μm. In some embodiments, the ionomer coating has a thickness of about 20 μm to about 40 μm. In some embodiments, the ionomer coating has a thickness of about 60 μm to about 80 μm.

In some embodiments, the voltage of operation per unit electrochemical cell comprising the gas diffusion anode of the present application is about 1.2V to about 4.2V at 70° C. and 4000 A/m². In some embodiments, the voltage of operation is about 1.5V to about 2.8V at 70° C. and 4000 A/m². In some embodiments, the voltage of operation is about 2.0V to about 3.2V at 70° C. and 4000 A/m². In some embodiments, the voltage of operation is about 2.2V to about 3.8V at 70° C. and 4000 A/m².

In some embodiments, the specific energy consumption is about 1200 kWh/ton of Na₂SO₄ to about 5000kWh/ton of Na₂SO₄ at 70° C. and 4000 A/m². In some embodiments, the specific energy consumption is about 1500kWh/ton of Na₂SO₄ to about 3500kWh/ton of Na₂SO₄ at 70° C. and 4000 A/m². In some embodiments, the specific energy consumption is about 1800kWh/ton of Na₂SO₄ to about 4500kWh/ton of Na₂SO₄ at 70° C. and 4000 A/m².

In some embodiments, the current efficiency for 0 to 60% conversion is about 70% to about 98% at 70° C. and 4000 A/m². In some embodiments, the current efficiency for 0 to 60% conversion is about 80% to about 98% at 70° C. and 4000 A/m². In some embodiments, the current efficiency for 0 to 50% conversion is about 65% to about 80% at 70° C. and 4000 A/m². In some embodiments, the current efficiency for 0 to 50% conversion is about 85% to about 98% at 70° C. and 4000 A/m².

Also provided is an electrochemical system comprising: a cathode, the gas diffusion anode of the present application, and a cell membrane positioned between the cathode and gas diffusion anode, wherein the cathode and the cell membrane define a catholyte channel therebetween, and the gas diffusion anode and the cell membrane define an anolyte channel therebetween.

The present application further includes a method of operating an electrochemical system of the present application, the method comprising: flowing a catholyte into the catholyte channel of the electrochemical system, wherein the catholyte comprises at least water; flowing an anolyte into the anolyte channel of the electrochemical system, wherein the anolyte comprises a metal salt in the form of metal cations and anions; flowing hydrogen gas into the gas diffusion anode of the electrochemical system; and applying a voltage between the cathode and the gas diffusion anode thereby converting the hydrogen gas into protons, being released into the anolyte, and driving the metal cations across the cell membrane of the electrolytic cell from the anolyte to the catholyte.

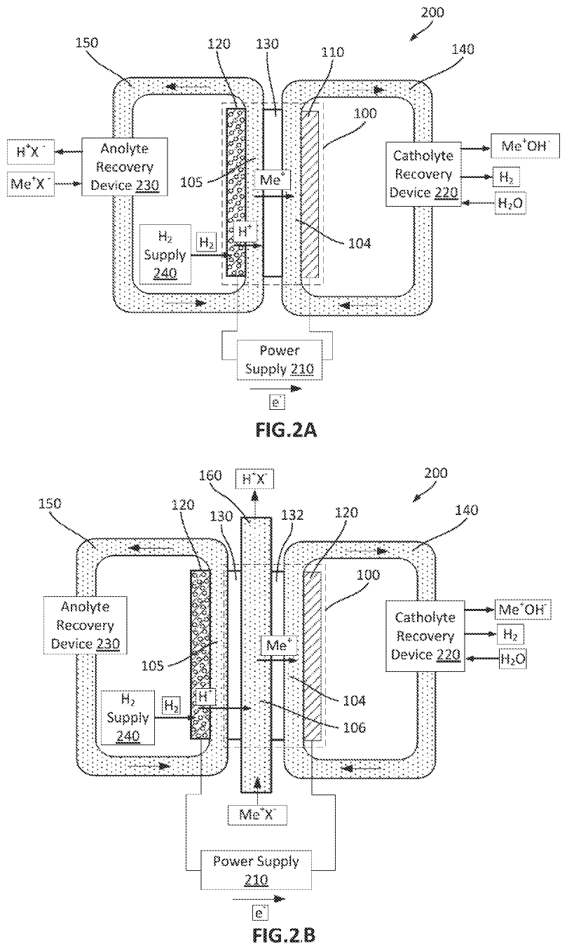

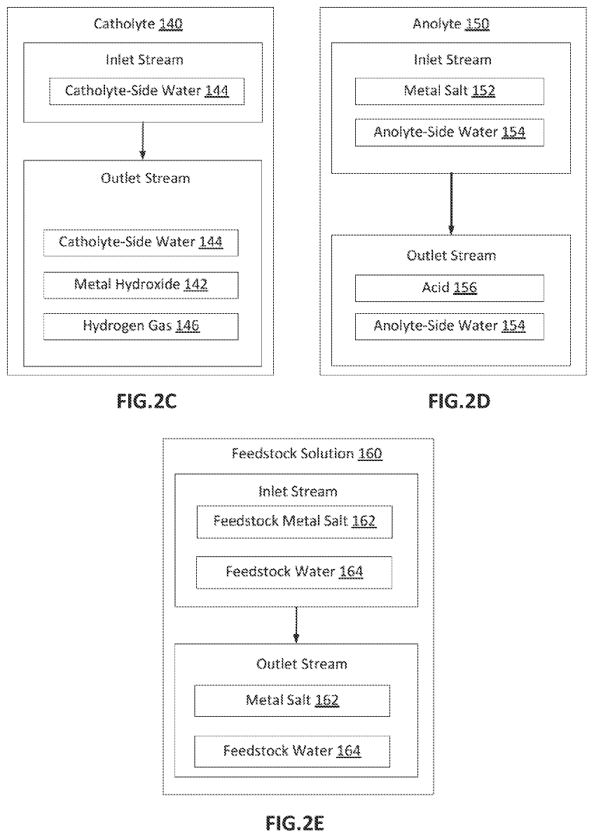

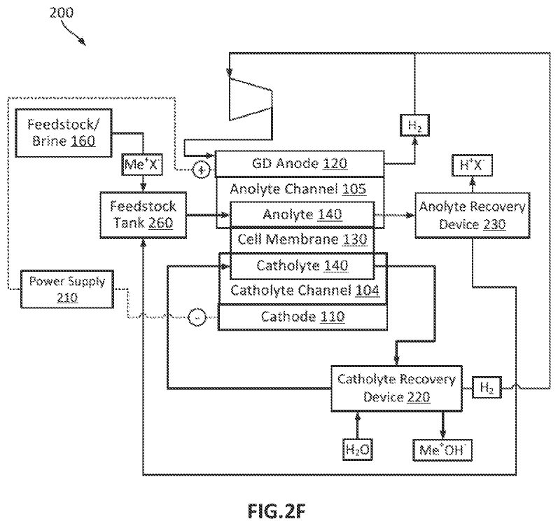

### FIGS. 2A-2F—Electrolytic System Examples

FIG. 2A is a schematic view of electrolytic system 200, in accordance with some examples. This type of system may be referred to as a 2-channel system to differentiate from a 3-channel system shown in FIG. 2B and described below. However, many components of the 2-channel system and the 3-channel system are the same.

Referring to FIG. 2A, electrolytic system 200 comprises electrolytic cell 100, power supply 210, catholyte recovery device 220, anolyte recovery device 230, and hydrogen supply device 240. As described above, electrolytic cell 100 comprises cathode 110, gas diffusion anode 120, and cell membrane 130 positioned between cathode 110 and gas diffusion anode 120.

Cathode 110 can be formed from stainless steel (e.g., 316, 316L) or a nickel alloy (e.g., Hastelloy). Cathode 110 can be in the form of one or more plates, mesh, and/or expanded metal foam. In some examples, a gap between cathode 110 and cell membrane 130 (which may be referred to as catholyte channel 104) is used to let the hydrogen gas bubbles flow out of electrolytic cell 100. Alternatively, cathode 110 can be in direct contact with cell membrane 130, e.g., to reduce the overall resistance of electrolytic cell 100. For example, a gap behind cathode 110 (on the other side from cell membrane 130) can be used for the accumulation of gas bubbles away from the membrane/cathode interface. In some examples, cathode 110 is porous (e.g., formed using powder processing and adjusting the hydrophobicity of the layer across its thickness). Some structural features of cathode 110 can be similar to that of gas diffusion anode 120 (described below). In these examples, instead of bubbling the hydrogen gas into catholyte channel 104 as a secondary phase, the hydrogen gas can directly evolve into a gas chamber that is in contact with the “back”of cathode 110.

Cell membrane 130 can also be referred to as a primary membrane to differentiate from various membrane structures of gas diffusion anode 120. Cell membrane 130 can be also referred to as a cation exchange membrane (CEM) or, more specifically, a cation-selective membrane (e.g., NAFION™ 424, NAFION™ 324, NAFION™ 2030, NAFION™ 2050 available from The Chemours Company in Wilmington, Delaware). For example, cell membrane 130 can be a proton-selective membrane, e.g., a bi-layer membrane with (1) a high conductivity/low equivalent weight (EW) ionomer composition on the anolyte side, and (2) a hydroxide-blocking lower-water uptake, lower conductivity ionomer coating on the catholyte side. A secondary layer can be used on the catholyte side for blocking hydroxide ions, such that this layer is formed from either a high EW ionomer (1400-1600 EW) (e.g., N424, N324) or a carboxylic layer (N2030 and N2050). This blocking capability can be used for the described applications since acids and bases are produced on opposite sides of the membrane (e.g., in a 2-compartment design). If the hydroxides start migrating across cell membrane 130 from catholyte 140 to anolyte 150, neutralization can happen, which significantly reduces the current efficiency of the process and is not desirable. Cell membrane 130 can pass various cations, e.g., sodium cations, lithium cations, potassium cations, and hydrogen cations/protons. In some examples, cell membrane 130 is reinforced with a woven polytetrafluoroethylene (PTFE) yarn or a 3D-printed expanded mesh to provide better structural stability to the membrane and promote turbulence and gas bubble removal. In some examples, cell membrane 130 is temperature stable up to 80° C., up to 90° C., or even up to 100° C.

Referring to FIG. 2A, in some examples, electrolytic cell 100 also comprises catholyte channel 104 and anolyte channel 105. Catholyte channel 104 is positioned between cathode 110 and cell membrane 130 and is used to flow catholyte 140 through electrolytic cell 100. As noted above, catholyte channel 104 can be used to remove the hydrogen gas as well as metal from electrolytic cell 100. Catholyte channel 104 can also be used to supply water to electrolytic cell 100. Anolyte channel 105 is positioned between gas diffusion anode 120 and cell membrane 130 and is used to flow anolyte 150 through electrolytic cell 100 (e.g., to supply the feedstock/metal salt to and remove acid from catholyte channel 104 can be used to remove the hydrogen gas as well as metal from electrolytic cell 100). As shown in FIG. 2A, cell membrane 130 can separate catholyte channel 104 and anolyte channel 105, e.g., in a 2-channel system. The 2-channel system can be also referred to as a single-membrane system.

FIG. 2B illustrates an example of a 3-channel system, in which electrolytic cell 100 comprises additional membrane 132 and feedstock channel 106. Feedstock channel 106 is positioned between cell membrane 130 and additional membrane 132. Specifically, additional membrane 132 is positioned between feedstock channel 106 and catholyte channel 104, while cell membrane 130 is positioned between feedstock channel 106 and anolyte channel 105. Feedstock channel 106 is used to flow feedstock solution 160 through electrolytic cell 100 in a 3-channel system. In this system, feedstock/metal salt can be supplied as a part of feedstock solution 160 rather than anolyte 150 (as in the 2-channel system)

Catholyte recovery device 220 is used to process catholyte 140 after catholyte 140 exits from electrolytic cell 100, which may be referred to as processed/spent catholyte. For example, catholyte recovery device 220 is used to remove a metal hydroxide and/or hydrogen gas from the spent catholyte. Catholyte recovery device 220 can be also used to introduce more water (e.g., to replenish any consumed water). In some examples, catholyte recovery device 220 is used to control the temperature of catholyte 140, e.g., to heat catholyte 140 to a desired processing temperature.

Anolyte recovery device 230 is used to process anolyte 150 after anolyte 150 exits from electrolytic cell 100, which may be referred to as processed/spent catholyte. For example, anolyte recovery device 230 may remove acid (e.g., sulfuric acid, hydrochloric acid) from anolyte 150 and introduce metal salt (e.g., in the form of a brine). In some examples, anolyte recovery device 230 is used to control the temperature of anolyte 150, e.g., to heat anolyte 150 to a desired processing temperature.

Hydrogen supply device 240 is fluidically coupled directly to gas diffusion anode 120 and is used to introduce hydrogen gas to gas diffusion anode 120. As further described below, this hydrogen gas passes through gas diffusion anode 120 and is converted into protons that are introduced into anolyte 150. Hydrogen supply device 240 can be configured to provide hydrogen gas at a set pressure, which is determined by the configuration of gas diffusion anode 120. Furthermore, hydrogen supply device 240 can be configured to provide hydrogen gas at a set flow rate, which is also determined by the configuration of gas diffusion anode 120 as well as by the processing rate of electrolytic cell 100 (e.g., the current flowing through electrolytic cell 100). Hydrogen source for the hydrogen supply device can be from the collected hydrogen gas evolving at the cathode of the same electrochemical cell.

Referring to FIG. 2C, the inlet stream of catholyte 140 comprises catholyte-side water 144. Other components, in the inlet stream, can be metal hydroxide 142 and/or hydrogen gas 146 (e.g., building up in catholyte 140 as catholyte 140 recirculates through electrolytic cell 100). To keep the concentration of various catholyte components constant (e.g., the concentration of metal hydroxide 142) and not increase the voltage of the system over time, a monitoring system is implemented to the catholyte stream to dose the required amount of catholyte-side water 144 (e.g., deionized (DI) water) into catholyte 140 to keep the concentration of various components constant. This means, over time/multiple passes through electrolytic cell 100, the volume of catholyte 140 increases. This extra volume of catholyte 140 (in the form of a caustic solution) can be continuously taken away as the product. This approach may be referred to as a “feed and bleed” approach/system/process. The concentration of metal hydroxide 142 in the outlet stream of catholyte 140 can be maintained at 5-30% by weight, e.g., below the maximum solubility (e.g., 1M-9M) of metal hydroxide 142 in water. In some examples, metal hydroxide 142 (or any other conductive additive) is added into catholyte 140 to increase the conductivity of catholyte 140. Hydrogen gas 146 can be removed from catholyte 140 using gas-liquid separation, e.g., performed in catholyte recovery device 220 in addition to the feed of catholyte-side water 144 and the removal of metal hydroxide 142 (e.g., a part of catholyte 140).

Alternatively, a skilled person in the art will appreciate that the “feed and bleed” approach/system/process may be applied to the anolyte stream, where flows described above are integrated on the anolyte stream. This way, the total salt concentration of the anolyte stream can be kept constant with continuous water dosing. During operation, as there is continuous acidification happening on the anolyte stream, continuous dosing of sodium sulfate is also necessary to keep the molar ratio of acid to salt below 60%.

Referring to FIG. 2D, in some examples, anolyte 150 comprises metal salt 152 (e.g., sodium sulfate (Na₂SO₄), lithium sulfate (Li₂SO₄), sodium chloride (NaCl), lithium chloride (LiCl), potassium chloride (KCl), potassium sulfate (K₂SO₄), and sodium acetate (CH₂COONa). The concentration of metal salt 152 in anolyte 150 can be 5-25% or 5-75% by weight, e.g., below the maximum solubility limit (e.g., 2M-4.5M or 2M-10M) of the referenced metal salts in water at the processing temperatures in question. A higher salt concentration produces a higher conductivity within the system thereby lowering the operational potential. Also, a higher salt concentration simplifies various post-processing operations performed on anolyte 150. A higher salt concentration requires less anolyte-side water 154 and reduces the overall volume of anolyte 150, thereby reducing flow rates/pumping requirements. It should be noted that the composition of anolyte 150 and catholyte 140 changes during the operation of electrolytic system 200, both within electrolytic cell 100, catholyte recovery device 220, and anolyte recovery device 230. For purposes of this disclosure, all references to the composition of anolyte 150 and catholyte 140 are made in the context of the incoming streams delivered to electrolytic cell 100, unless specifically mentioned otherwise.

Referring to FIG. 2E, in some examples (when electrolytic cell 100 comprises feedstock channel 106), feedstock solution 160 comprises feedstock metal salt 162 and feedstock water 164 on both the inlet and outlet side. In this example, anolyte 150 may or may not contain metal salt 152 (e.g., some metal salt 152 may be present in anolyte 150 to ensure conductivity). The composition and other aspects of feedstock solution 160 will be understood by one having ordinary skill in the art from the description of catholyte 140 and anolyte 150 presented above.

FIG. 2F is a schematic flowchart of electrolytic system 200 illustrating various connections and flow streams, in accordance with some examples. Some aspects of electrolytic system 200 are described above with reference to FIG. 2A.

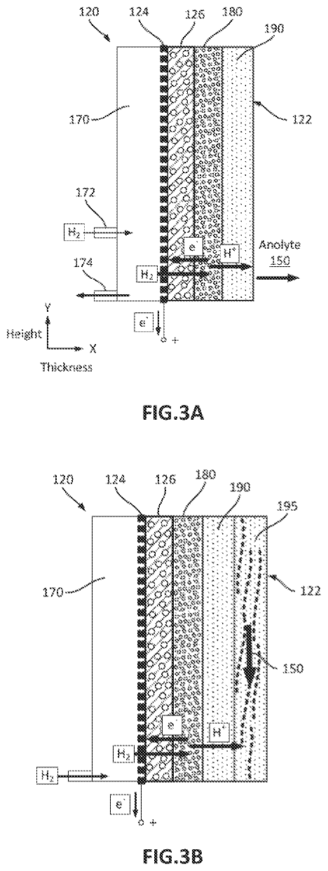

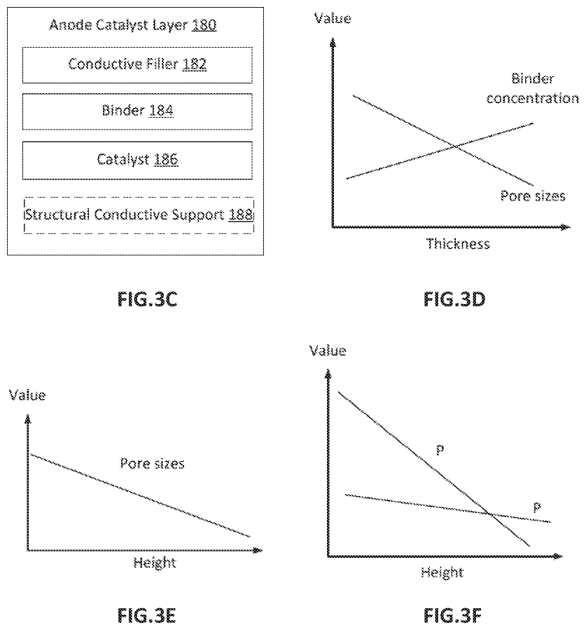

### FIG. 3A-3F: Examples of Gas Diffusion Anodes

Referring to FIG. 3A, in some examples, gas diffusion anode 120 comprises anode gas chamber 170, current collector 124, anode porous base 126, anode catalyst layer 180, and anode-liquid interfacing layer 190. Current collector 124 is positioned adjacent to the anode gas chamber 170. Anode porous base 126 is positioned adjacent to current collector 124. Specifically, current collector 124 is positioned between anode gas chamber 170 and anode porous base 126. Anode catalyst layer 180 is positioned adjacent to anode porous base 126. Specifically, anode catalyst layer 180 is positioned between anode porous base 126 and anode-liquid interfacing layer 190. Anode-liquid interfacing layer 190 is positioned adjacent to anode catalyst layer 180. In some examples, anode-liquid interfacing layer 190 is one of the outside structures of gas diffusion anode 120. Specifically, anode-liquid interfacing layer 190 forms anode liquid-side outer surface 122 that is exposed.

Referring to FIG. 3B, in some examples, gas diffusion anode 120 comprises anolyte falling-film structure 195 positioned adjacent to anode-liquid interfacing layer 190. Specifically, anode-liquid interfacing layer 190 is positioned between anode catalyst layer 180 and anolyte falling-film structure 195. In these examples, anolyte falling-film structure 195 is an outside structure of gas diffusion anode 120. Specifically, anolyte falling-film structure 195 forms anode liquid-side outer surface 122 that is exposed. Additional features of anolyte falling-film structure 195 are described below.

Anode gas chamber 170 is a compartment for feeding hydrogen gas. Anode gas chamber 170 can be filled with current collector 124 (e.g., multiple metal current collectors of different sizes) to provide electrical contact between gas diffusion anode 120 and power supply 210 (e.g., voltage-carrying contactor plates that connect gas diffusion anode 120 and power supply 210). In some examples, anode gas chamber 170 comprises hydrogen-receiving gas inlet 172 (e.g., fluidically coupled to hydrogen supply 240). In some examples, anode gas chamber 170 comprises liquid outlet 174 for removing any liquid passing through gas diffusion anode 120. While various layers of gas diffusion anode 120 are configured to prevent liquid (e.g., anolyte 150) from passing into anode gas chamber 170, some liquid may still pass. This liquid may be gravitationally collected at the bottom of anode gas chamber 170 and removed through liquid outlet 174.

In some examples, current collector 124 comprises a metal or conductive mesh. Current collector 124 allows hydrogen gas to pass from anode gas chamber 170 to anode porous base 126. In some examples, current collector 124 also provides a mechanical support function, e.g., to support other components of gas diffusion anode 120. In some examples, current collector 124 is a multilayered structure, e.g., multiple metal or conductive current collectors of different sizes formed a stack.

In some examples, anode porous base 126 is a porous electronically-conductive structure. Anode porous base 126 ensures uniform distribution of hydrogen gas to anode catalyst layer 180 while also providing electronic conductivity (uniform current density) between anode catalyst layer 180 and current collector 124. For example, anode porous base 126 can be an open-cell metal foam or such structures. In some examples, anode porous base 126 has a variable porosity across the thickness of anode porous base 126 (e.g., a higher porosity on the current collector side and a lower porosity on the catalyst layer side). In some examples, anode porous base 126 has a variable pore size across the thickness of anode porous base 126 (e.g., larger pores porosity on the current collector side and smaller pores on the catalyst layer side).

In some examples, the average porosity of anode porous base 126 can be between 60% and 85% or 20% and 90%. In some examples, the porosity varies across the thickness and/or along the height of anode porous base 126. For example, the porosity can decrease from the current-collector-facing side of anode porous base 126 to the catalyst-layer-facing side. In some examples, the pore sizes can decrease from the current-collector-facing side of anode porous base 126 to the catalyst-layer-facing side. In some examples, the pore sizes can decrease from the top of anode porous base 126 to the bottom, e.g., as schematically shown in FIG. 3E. The top and bottom are defined by the height of anode porous base 126 corresponding to the gravitation vertical. In some examples, the porosity decreases from the top of anode porous base 126 to the bottom.

Referring to FIG. 3C, in some examples, anode catalyst layer 180 comprising conductive filler 182, binder 184, and/or catalyst 186. Some examples of materials suitable for conductive filler 182 include but are not limited to graphite powder, carbon black, mesocarbon microbeads, activated carbon, carbon nanotubes, graphene, titanium carbide or a combination thereof, as well as powders and fibers of stainless steel (e.g., 316, 316L), titanium, nickel, and conductive oxides of other metals can be used. These materials are conductive and chemically stable under the hydrogen evolution reaction (HER) anodic potentials (e.g., between −0.5 V and 1 V vs. the standard hydrogen reference electrode). The portion of conductive filler 182 in anode catalyst layer 180 can be between 50 weight % and 98 weight % or, more specifically, 75 weight % and 95 weight %.

Some examples of materials suitable for catalyst 186 include but are not limited to platinum on carbon (Pt—C), platinum black, iridium oxide, nickel, palladium, rhodium, ruthenium, oxides of titanium with the general formula Ti₍ₙ₎O₍₂ₙ₋₁₎, or a combination thereof and other HOR catalysts. Catalyst 186 may be in the form of particles with a particle size in the size range of 8-500 nanometers. When the catalyst particles are supported on other structures, the size of these catalyst particles can be 2-8 micrometers. As the catalyst particles are small, they tend to coagulate over time and cause loss of active area. Therefore, in some examples, these particles are stabilized (e.g., adhered to) on secondary structures (e.g., carbon particles) to keep them smaller for longer periods. In this example, platinum (Pt) catalyst particles are in the nanometer range, while larger carbon particles are in the micron range. The portion of catalyst 186 in anode catalyst layer 180 (which may be referred to as catalyst load) can be between 0.1 weight % and 5 weight %.

In some examples, anode catalyst layer 180 has an average porosity less than that of anode porous base 126. For example, the average porosity of anode catalyst layer 180 can be between 85% and 98%, or 5% and 60%. In some examples, the porosity varies across the thickness and/or along the height of anode catalyst layer 180 as, e.g., is schematically shown in FIG. 3D. For example, the porosity can decrease from the porous-base-facing side of anode catalyst layer 180 to the liquid-interfacing-layer-facing side. In some examples, the pore sizes can decrease from the porous-base-facing side of anode catalyst layer 180 to the liquid-interfacing-layer-facing side. In some examples, the pore sizes can decrease from the top to the bottom of anode catalyst layer 180. Similar to anode porous base 126 (described above), the top and bottom are defined by the height of anode catalyst layer 180 corresponding to the gravitation vertical. In some examples, the porosity decreases from the top to the bottom of anode catalyst layer 180. Another variability can be attributed to the hydrophobicity, e.g., the hydrophobicity can increase from the porous-base-facing side of anode catalyst layer 180 to the liquid-interfacing-layer-facing side. In some examples, the hydrophobicity is determined by the concentration of binder 184 in anode catalyst layer 180, e.g., the concentration of binder 184 can increase from the porous-base-facing side of anode catalyst layer 180 to the liquid-interfacing-layer-facing side.

Some examples of materials suitable for anode-liquid interfacing layer 190 include but are not limited to PTFE, and NAFION Ionomers (EW 1100-1800). Anode-liquid interfacing layer 190 should be able to withstand temperatures up to 80° C., up to 100° C., or even up to 120° C. In some examples, anode-liquid interfacing layer 190 has a low water transport (e.g., provided by the porosity and/or hydrophobicity). In some examples, anode-liquid interfacing layer 190 has a high proton conductivity (e.g., provided by the composition).

In some examples, anode-liquid interfacing layer 190 comprises a porous polymer base and an ionomer coating, configured to conduct protons through the anode-liquid interfacing layer 190. Some examples of materials suitable for the porous polymer base include but are not limited to polypropylene (PP), polyethylene (PE) or polyvinylidene fluoride (PVDF), PBI (polybenzimidazole), Nafion™, and/or polytetrafluoroethylene (PTFE). Some examples of materials suitable for the porous ionomer coating include but are not limited to NAFION™-based ionomers (e.g., EW 800-1600), sulfuric acid doped PBI (polybenzimidazole) polymer, sulfonated s-PBI (s-polybenzimidazole). Depending on the application, other long side-chain and short side-chain proton conductor ionomers can be used.

Overall, gas diffusion anode 120 uses a multi-layer approach producing different hydrophobicity characteristics on the gas side (i.e., within anode gas chamber 170) and the liquid side (e.g., anolyte channel 105 and/or anolyte falling-film structure 195) of gas diffusion anode 120. For example, the gas side (e.g., anode porous base 126) can be significantly more hydrophobic than the liquid side (e.g., anode-liquid interfacing layer 190) to prevent the migration of anolyte 150 to the gas side. Furthermore, this hydrophobicity variability can be present in the same component (e.g., anode porous base 126 and/or anode-liquid interfacing layer 190) and change across the component thickness (i.e., the X direction in FIGS. 3A and 3B) and/or along the component height (i.e., the Y direction in FIGS. 3A and 3B). For example, the hydrophobicity variability can be achieved by different ratios of hydrophobicity promoter materials (e.g., polytetrafluoroethylene (PTFE), polyvinylidene fluoride (PVDF), silane). For example, the amount of PTFE on the gas side can be as high as 5-10 wt. % or 5-50 wt. % of the total weight of anode porous base 126, whereas the PTFE ratio on the electrolyte side can be around 0.5-4 wt. %.

The hydrophobicity of the two opposite faces can be measured using contact angle measurement testing on both sides. Another method is to subject gas diffusion anode 120 to a liquid/gas cell where the liquid gets pressurized until the liquid breaks into the electrode and floods, while measuring the pressure difference. At least a pressure difference of 150-300 mBar or 100-500 mBar should not cause any penetration of the liquid into the pores.

In some examples, gas diffusion anode 120 has water-hydrodynamic stability corresponding to the pressure differences between the gas and liquid sides of at least 100 mBar or even at least 150 mBar, e.g., up to 250 mBar or even up to 300 mBar or 500 mBar. In other words, anolyte 150 can apply this pressure on the liquid size of gas diffusion anode 120 without leaking to the gas side. This water-hydrodynamic stability is achieved using a combination of the porosity and hydrophobicity characteristics of different components of gas diffusion anode 120, which are described above with the reference to specific components.

In some examples, gas diffusion anode 120 is configured to withstand temperatures of up to 90° C. such as 60-75° C., 78-84° C., or 85-88° C. or up to 100° C. such as 60-75°C., 76-84° C., 85-88° C. or 85-98° C. It should be noted that anolyte 150 is maintained at a temperature of at least 50° C. (e.g., 70-85° C.) to ensure high kinetic and mass-transport levels. All of the materials should have melting/softening temperatures above the desired operating temperature and the catalyst should not be dissolving into the anolyte over time.

In some examples, gas diffusion anode 120 is configured to maintain the stable operation up to a current density of 6000 A/m² more likely in the range of 4000-5500 A/m² or 3000-5500 A/m² (based on the surface area of gas diffusion anode 120). It should be noted that the current density corresponds to the production rate of electrolytic system 200.

Referring to FIG. 3F, in some examples, the pressure that anolyte 150 exerts on gas diffusion anode 120 is limited to the weight of anolyte 150 (effectively eliminating any pumping/fluid dynamics pressure). This pressure control can be achieved by using an “open cell” design, which can be also referred to as “falling film electrolysis”. In these examples, anolyte 150 is flowed over gas diffusion anode 120 with the help of gravity (rather than pressurized pumping). In some examples, the angle of the electrode inside the electrolysis cell can be substantially parallel to the direction of gravity. In some cases, electrolytic cell 100 can be operated at an angle with the gravitational direction up to 45°, more specifically 30-45°. Furthermore, in these examples, anode-liquid interfacing layer 190 may or may not be needed. Anolyte falling-film structure 195 may be directly coated over anode catalyst layer 180.

In this “open” cell design, the control of the mass transport of chemical species can be used for maintaining a high current density. To achieve this, a “falling film” type cloth material will be used to promote mass transport and regulate the hydrodynamic pressure of the liquid electrolyte stream. This cloth material can consist of knit or woven patterns of fibers, with controlled hydrophobicity and wicking capacity. Materials could be fluorinated polymers such as TEFLON™, PVDF, polyvinyl chloride (PVC), and ethylene propylene diene monomer (EPDM), as well as other chemical-resistant polymers. Furthermore, the falling film structures can be directly printed on the anode-liquid interfacing layer as 3D structures and geometrical patterns.

### FIG. 3B—A node Falling Film Examples

In some examples, gas diffusion anode 120 comprises anolyte falling-film structure 195 to prevent flooding of the gas compartment of gas diffusion anode 120 or, more specifically, to prevent anolyte 150 from flowing to the gas compartment from the anolyte size of gas diffusion anode 120. This flooding prevention can also be referred to as hydrodynamic stability of gas diffusion anode 120. For example, tuning the hydrophobicity of anode-liquid interfacing layer 190 as well as anode porous base 126 and/or other components of gas diffusion anode 120, on its own, may not be enough to prevent anolyte 150 from penetrating into the pores of anode-liquid interfacing layer 190.

In some examples, anolyte falling-film structure 195 can be positioned on anode-liquid interfacing layer 190. Anolyte falling-film structure 195 can be a porous structure formed from polypropylene (PP), and/or polyethylene (PE), polyvinylidene fluoride (PVDF), PBI (polybenzimidazole), Nafion™, and/or polytetrafluoroethylene (PTFE). The pore sizes can be in the range of 50-200 nanometers or 40-500 nanometers. In more specific examples, anolyte falling-film structure 195 comprises an ionomer coating, which is applied to the porous structure to create a protective barrier between anode-liquid interfacing layer 190 and anolyte 150. The ionomer coating can comprise a fluoropolymer (e.g., NAFION™-type material) that is proton conductive and, therefore, allows the transport of protons from anode-liquid interfacing layer 190 to anolyte 150, while creating an additional hydrodynamic resistance to anolyte 150 preventing anolyte 150 from penetrating into the gas compartment.

Despite the presence of anolyte falling-film structure 195 and/or anode-liquid interfacing layer 190, the hydrodynamic pressure of anolyte 150 can still force some of anolyte 150 (e.g., water molecules) to transport gas diffusion anode 120 into anode gas chamber 170, which may be referred to as “flooding” resulting in poor performance (high voltage, low efficiency).

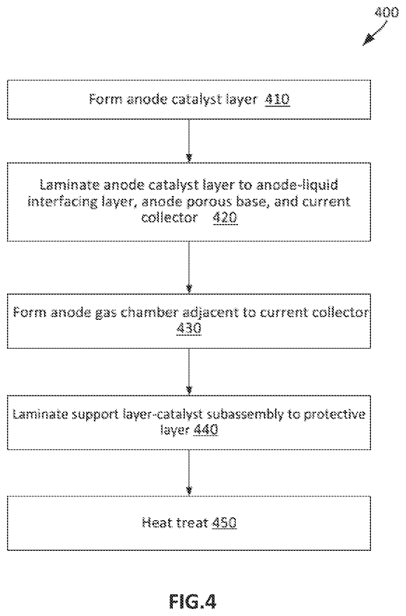

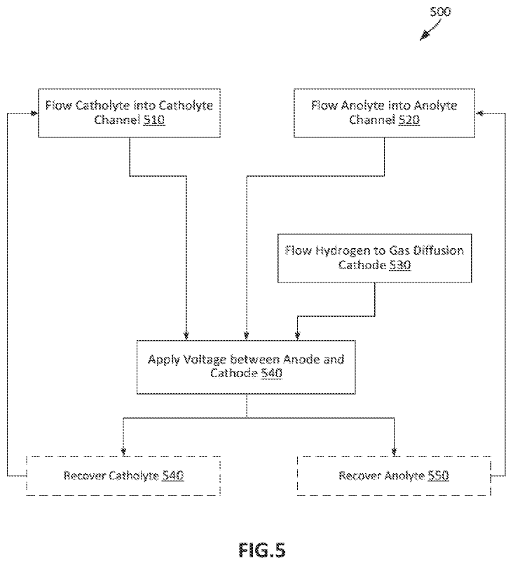

### FIG. 4—Examples of Fabricating GDEs (Specific to Sulfate Electrolysis)

FIG. 4 is a process flowchart corresponding to method 400 for fabricating gas diffusion anode 120, in accordance with some examples.

Method 400 may commence with (block 410) forming anode catalyst layer 180. For example, this operation may involve the mixing of conductive filler 182 (e.g., in a powder form), binder 184 (e.g., a polymer binder in a powder form), and/or catalyst 186 (e.g., in a powder form). Various examples of these components are described above.

Some examples of suitable catalysts include, but are not limited to, platinum on carbon (Pt—C), platinum black, iridium oxide, nickel, palladium, rhodium, ruthenium, oxides of titanium with the general formula Ti₍ₙ₎O₍₂ₙ₋₁₎, or a combination thereof and other hydrogen oxidation reaction (HOR) catalysts, with particles in the size range of 8-200 nanometers. In some examples, a polymer base is PTFE powder with a particle size range of 20-80 micrometers or 5-90 micrometers. The filler material should be conductive and chemically stable under the HOR anodic potentials. Powders and fibers of graphite powder, carbon black, mesocarbon microbeads, activated carbon, carbon nanotubes, graphene, titanium carbide or a combination thereof, as well as powders and fibers of stainless steel (e.g., 316, 316L), titanium, nickel, and conductive oxides of other metals can be used.

Method 400 proceeds with (block 420) compacting the mixture, e.g., by applying pressure to the mixture (e.g., passing the mixture through a roll press/calendaring). Specifically, this calendaring process applies pressure to the powder mixture, compacting the constituents of the catalyst layer.

Method 400 proceeds with (block 430) laminating the compacted mixture to a conductive support layer thereby forming a support layer-catalyst subassembly. This operation may involve passing a stack of the compacted mixture and the conductive support layer through another roll press/second calendaring process to promote bonding between the support layer and the catalyst-containing layer. In some examples, the support layer can be made out of mesh or expanded sheet forms of metals or conductive materials such as titanium, stainless steel (e.g., 316, 316L), nickel, and other chemically resistant metals or conductive materials. In other examples, the conductive support layer can also be made from fibers of metals such as stainless steel and titanium. The porosity of the support layer can be varying across its thickness to allow controlled transport of gaseous and liquid species.

Method 400 proceeds with (block 440) laminating the support layer-catalyst subassembly to a protective layer, which can be also referred to as a hydrophobic-coating layer. This hydrophobic layer might have a coating of ionomers to improve the proton transport while creating hydrodynamic pressure to prevent the flooding of gas diffusion anode 120.

Method 400 proceeds with (block 450) heat treating to increase the bonding between the layers and help remove any solvent impurities. For example, an oven or belt heater-type process or a heat press process can be employed to treat electrodes at temperatures not more than 240° C. and not less than 120° C., or not less than 80° C.

In some examples, various operations described above are performed in a continuous (e.g., “roll to roll”) manner.

### FIG. 5—Operating Method Examples

FIG. 5 is a process flowchart corresponding to method 500 of operating the electrolytic system 200, in accordance with some examples. Various examples of electrolytic system 200 are described above. It should be noted that method 500 can be used to convert various salts (e.g., sulfates such as Li₂SO₄, Na₂SO₄, K₂SO₄, chlorides such as LiCl, NaCl, and KCl, and organic salts such as sodium acetate (CH₃COONa)) to acid (e.g., sulfuric acid (H₂SO₄), hydrochloric acid (HCl), acetic acid(CH₃COOH) and metal hydroxides (e.g., LiOH, NaOH).

In some examples, method 500 comprises (block 510) flowing catholyte 140 into catholyte channel 104 of electrolytic cell 100. For example, catholyte 140 can flow at a flow rate of 0.5-5 m³/hr per each 1 m² of the area of cathode 110 or, more specifically, at flow rates of 1-3 m³/hr-m². Catholyte 140 may be at the temperature between 60-90° C. or, more specifically, 75-85° C. upon reaching catholyte channel 104.

In some examples, method 500 comprises (block 520) flowing anolyte 150 into anolyte channel 105 of electrolytic cell 100. For example, anolyte 150 can flow at a flow rate of 0.5-5 m³/hr per each 1 m² of the area of gas diffusion anode 120 or, more specifically, at flowrates of 1-3 m³/hr-m². Anolyte 150 may be at the temperature between 60-90° C. or, more specifically, 75-85° C. upon reaching anolyte channel 105.

In some examples, method 500 comprises (block 525) flowing feedstock solution 160 into feedstock channel 106 of electrolytic cell 100 at flow rates ranging from 0.5-3 m³/hr-m². Feedstock solution 160 may be at the temperature between 60-90° C. or, more specifically, 75-85° C. upon reaching feedstock channel 106. As noted above, this operation is performed in three-channel systems and is optional.

In some examples, method 500 comprises (block 530) flowing hydrogen gas into gas diffusion anode 120. The pressure can be up to 1.5 bar or, more specifically, 400 mBar-900 mBar. The temperature can be above 50° C., such as 60-90° C. At an operating current density of 4000 A/m², the flow rate can be up to 50 liters/min-m² more likely 25-40 liters/min-m².

In some examples, method 500 proceeds with (block 540) applying a voltage between cathode 110 and gas diffusion anode 120. The voltage is determined based on the electrochemical reaction in the system as described above with reference to FIG. 1C. The internal system resistance is another consideration. The application of voltage drives various electrochemical reactions at cathode 110 and gas diffusion anode 120 and drives metal cation from anolyte 150 to catholyte 140.

In some examples, method 500 comprises (block 550) recovering at least a portion of catholyte 140, e.g., using catholyte recovery device 220. This is an optional operation. During the catholyte recovery operation, metal hydroxide and/or hydrogen gas may be removed from catholyte 140. Water can be introduced to catholyte 140 to compensate for water consumed during the system operation.

In some examples, method 500 comprises (block 560) recovering at least a portion of anolyte 150, e.g., using anolyte recovery device 230. This may be an optional operation. During the anolyte recovery operation, acids may be removed from anolyte 150. Metal salts can be introduced to catholyte 140 to compensate for metal cations transferred to catholyte 140 during the system operation. Water can be introduced to anolyte 150 to compensate for water consumed during the system operation.

In some examples, the anolyte side of electrolytic cell 100 is operated in batch mode. In this mode, a fixed volume of anolyte 150 is loaded into electrolytic cell 100 (i.e., the anolyte chamber) and continuously recirculated within electrolytic cell 100 for a period of time. The applied voltage (between gas diffusion anode 120 and cathode 110) drives cations across cell membrane 130 (from anolyte 150 to catholyte). For example, for each sodium ion (Na⁺) that crosses cell membrane 130, the reaction at gas diffusion anode 120 produces one proton (H⁺) released in anolyte 150 thereby preserving the charge balance in anolyte 150. As such, during this batch operating period, anolyte 150 is getting “acidified”. In some examples, this batch process has above 90% current efficiency and up to 70% molar conversion (e.g., Na₂SO₄ into H₂SO₄). For purposes of this disclosure, the current efficiency is a ratio of electrons provided to the system that was actually used towards making the chemicals (e.g., H₂SO₄ and NaOH). For example, 90% current efficiency means 90% of the current supplied to the electrolysis unit actually produced the acid and the caustic (in molar stoichiometry). It should be noted higher conversion rates correspond to higher proton concentrations in anolyte 150 thereby driving protons through cell membrane 130 and causing a significant drop in efficiency. Therefore, at around 60-75% conversion of metal salt 152, the batch process is stopped and anolyte 150 is replaced.

In the same or other examples, a feed-and-bleed approach can be used on both the catholyte and anolyte side of electrolytic cell 100. The goal is to keep the stable/constant concentration of metal hydroxide 142 in catholyte 140 and stable/constant concentration of acid in anolyte 150. This concentration stabilization is achieved by using a conductivity probe and a density probe to continuously monitor the concentration of catholyte 140, with the conductivity and density representing the concentration of metal hydroxide 142. Specifically, as cations (e.g., Na⁺ or Li⁺) pass through cell membrane 130, and OH-ions are produced at cathode 110, the conductivity probe output is used to operate a dosing pump to deliver more water (e.g., DI water) into catholyte 140. This approach allows for keeping the concentration of metal hydroxide 142 in catholyte 140 at the same level. However, feeding water increases the volume of catholyte 140, which is partially bled out, collectively causing the feed-and-bleed effect.

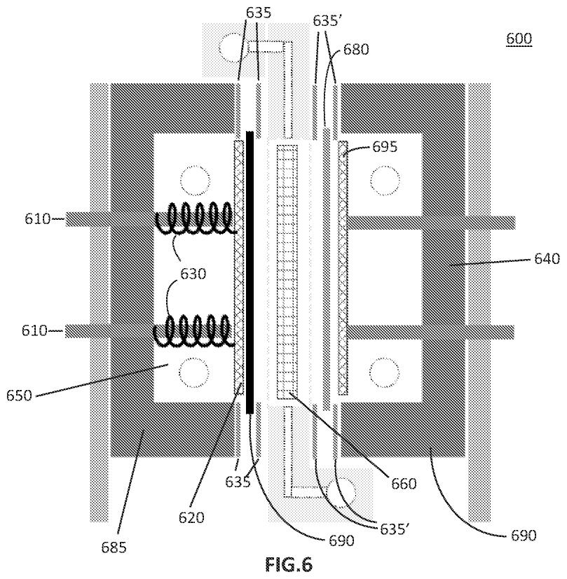

FIG. 6 is a schematic representation showing an exemplary embodiment of an electrochemical cell 600 with the gas diffusion anode of the present application. The rods 610 are welded to a conductive mesh 620 acting as the current collector. Spring-like compression structures 630 are attached to provide even distribution of compression on the gas diffusion anode to ensure good electrical contact (low contact resistance) and provide even distribution of current. Gas diffusion anode is sandwiched between gaskets/o-rings 635 to seal the liquid compartment 640 from the hydrogen gas chamber 650. A 3D structure 660 is adjacent to the anode-liquid facing layer 670 to ensure controlled flow. Cation exchange membrane 680 is sandwiched between gaskets/o-rings 635′ to seal the liquid anolyte compartment 685 from the catholyte compartment 690. A stainless steel or nickel-based cathode mesh 695 is pressed against the cation exchange membrane 680.

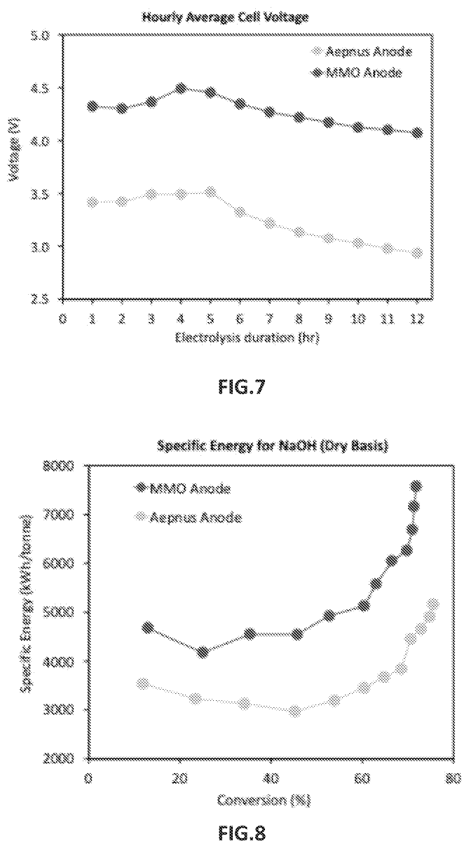

FIG. 7 is a plot showing the hourly averaged voltage readings for two different cell configurations. One cell contained a pristine gas diffusion electrode of the present application with 0.5 g/m² Pt catalyst loading on the anode and the other cell, the comparative cell, contained a pristine DSA-O₂ anode mesh with 20 g/m² iridium oxide catalyst coating (MMO anode). Tests were conducted using 25 cm² active area lab-scale electrochemical cells under 4000 A/m² and at a constant temperature of 70° C. 500 liters of 2.5 M sodium sulfate solution was fed into the anolyte compartment and recirculated in batch operation. 4M of sodium hydroxide solution was fed into the catholyte compartment recirculated under “feed and bleed” operation. The voltage response of the electrochemical cells were recorded over a period of 12 hours. Results show that \tilde{ }1.0 V reduction in voltage could be realized with the integration of the anode of the present application. After 10 hours of operation, with the acidification of the anolyte batch and resulting increase in anolyte conductivity, operating voltage of the cell of the present application reached below 3.0 V while the comparative MMO anode cell remained above 4V at all times.

FIG. 8 is a plot showing the specific energy consumed per ton of sodium suflate versus the molar acid conversion of the anolyte stream for the two different cell configurations under the same operating conditions described above. The specific energy for the anode of the present application is \tilde{ }1500 kWh less than the comparative MMO anode configuration, which is a 35% reduction in energy required for salt splitting. Without being bound to theory, the increase in specific energy for both cell configurations beyond 60% molar conversion may be due to the batch recirculation of the anolyte stream, which results in excess proton crossover across the cation exchange membrane towards the catholyte chamber above molar conversion rates of >60%. When the protons crossover instead of sodium ions, the protons neutralize the hydroxides generated at the cathode, resulting in poor current efficiency.

FIG. 9 is a plot showing the current efficiency versus the molar acid conversion of the anolyte stream for the two different cell configurations under the same operating conditions described above. The current efficiency of the anode of the present application reaches above 90%, whereas the comparative MMO anode configuration has slightly lower efficiency \tilde{ }82%, which is a 10% improvement in process efficiency with the use of anodes of the present application. Without wishing to be bound to theory, the drop in current efficiency for both cell configurations beyond 60% molar conversion may be due to the batch recirculation of the anolyte stream, which results in excess proton crossover across the cation exchange membrane towards the catholyte chamber above molar conversion rates of >60%. When the protons crossover instead of sodium ions, the protons neutralize the hydroxides generated at the cathode, resulting in poor current efficiency.

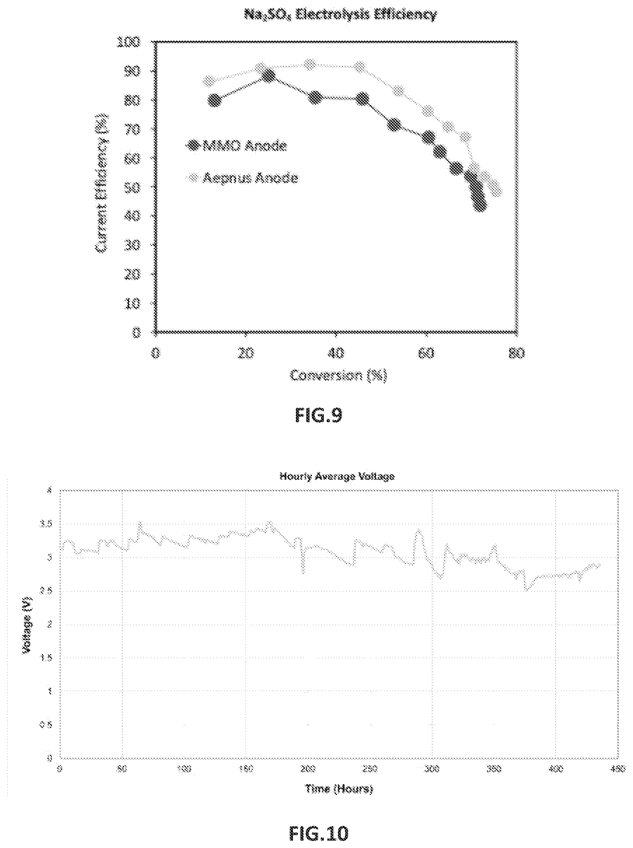

FIG. 10 is a plot showing the measured voltage of the anode configuration of the present application under the same operating conditions described above. Average operating voltage of the electrochemical cell of the present application remained relatively stable around \tilde{ }3V over a period of 440 hours. Without being bound to theory, this data set proves that no flooding occurs over long periods of operation, which would have caused significant increase in operating cell voltage. In addition, stable voltage reading also indicates that the GDEs of the present application are robust enough to withstand the corrosive conditions inside the electrochemical cell and remain relatively stable without loss of performance.

### Conclusion

Although the foregoing concepts have been described in some detail for purposes of clarity of understanding, it will be apparent that certain changes and modifications may be practiced within the scope of the appended claims. It should be noted that there are many alternative ways of implementing processes, systems, and apparatuses. Accordingly, the present embodiments are to be considered illustrative and not restrictive.

1: A gas diffusion anode, the gas diffusion anode comprising:
a current collector, comprising a conductive mesh;
an anode porous base positioned adjacent to the current collector, wherein the anode porous base comprises a porous electronically-conductive structure;
an anode catalyst layer positioned adjacent to the anode porous base, the anode catalyst layer comprising a conductive filler, a binder, and a catalyst, has an average porosity different than that of the anode porous base, and is positioned adjacent to the anode porous base such that the anode catalyst layer is positioned between the anode porous base and the anode-liquid interfacing layer; and
an anode-liquid interfacing layer positioned adjacent to the anode catalyst layer such that the anode catalyst layer is positioned between the anode porous base and the anode-liquid interfacing layer; the anode-liquid interfacing layer comprising a porous polymer base and an ionomer coating configured to conduct protons through the anode-liquid interfacing layer.

2: A gas diffusion anode for use in an electrochemical cell, the gas diffusion anode comprising:
an anode gas chamber;
a current collector positioned adjacent to the anode gas chamber such that the current collector is positioned between the anode gas chamber and the anode porous base, the current collector comprising a conductive mesh;
an anode porous base is positioned adjacent to the current collector, wherein the anode porous base comprises a porous electronically-conductive structure;
an anode catalyst layer positioned adjacent to the anode porous base, the anode catalyst layer comprising a conductive filler, a binder, and a catalyst, has an average porosity different than that of the anode porous base, and is positioned adjacent to the anode porous base such that the anode catalyst layer is positioned between the anode porous base and the anode-liquid interfacing layer; and
an anode-liquid interfacing layer positioned adjacent to the anode catalyst layer such that the anode catalyst layer is positioned between the anode porous base and the anode-liquid interfacing layer; the anode-liquid interfacing layer comprising a porous polymer base and an ionomer coating configured to conduct protons through the anode-liquid interfacing layer.

3: The gas diffusion anode of claim 1, wherein the anode-liquid interfacing layer comprises an exposed anode liquid-side outer surface.

4-32. (canceled)

33: A gas diffusion anode for use in an electrolytic cell for converting metal salts into metal hydroxides, the gas diffusion anode comprises:
an anode gas chamber;
a current collector, comprising a metal mesh and is positioned adjacent to the anode gas chamber;
an anode porous base is a porous electronically-conductive structure and is
positioned adjacent to the current collector such that the current collector is positioned between the anode gas chamber and the anode porous base;
an anode catalyst layer comprising a conductive filler, a binder, and a catalyst, has an average porosity less than that of the anode porous base, and is positioned adjacent to the anode porous base such that the anode catalyst layer is positioned between the anode porous base and the anode-liquid interfacing layer; and
an anode-liquid interfacing layer comprising a porous polymer base and an ionomer
coating configured to conduct protons through the anode-liquid interfacing layer,
wherein the anode-liquid interfacing layer is positioned adjacent to the anode catalyst layer.

34: The gas diffusion anode of claim 33, wherein the anode-liquid interfacing layer forms an anode liquid-side outer surface that is exposed.

35: The gas diffusion anode of claim 33, further comprising an anolyte falling-film structure positioned adjacent to the anode-liquid interfacing layer such that the anode-liquid interfacing layer is positioned between the anode catalyst layer and the anolyte falling-film structure.

36: The gas diffusion anode of claim 33, wherein the anode gas chamber comprises a hydrogen-receiving gas inlet.

37: The gas diffusion anode of claim 36, wherein the anode gas chamber comprises a liquid outlet for removing any liquid passing through the gas diffusion anode.

38: The gas diffusion anode of claim 33, wherein the current collector is formed from titanium.

39: The gas diffusion anode of claim 33, wherein the anode porous base has a variable porosity across the thickness and/or across the height of the anode porous base.

40: The gas diffusion anode of claim 33, wherein the anode catalyst layer further comprises a structural conductive support.

41: The gas diffusion anode of claim 33, wherein the porous polymer base comprises at least one of polyethylene (PP) or polypropylene (PP), PTFE, or PVDF.

42: The gas diffusion anode of claim 33, wherein the ionomer coating comprises perfluoro-sulfonic acid (PFSA) or PBI.

43: A electrolytic system comprising:
a cathode,
the gas diffusion anode of claim 33, and
a cell membrane positioned between the cathode and gas diffusion anode, wherein:
the cathode and the cell membrane define a catholyte channel therebetween, and
the gas diffusion anode and the cell membrane define an anolyte channel therebetween.

44-51. (canceled)

52: The method of claim 43, wherein the gas diffusion anode comprises:
an anode gas chamber;
a current collector, comprising a metal mesh and is positioned adjacent to the anode
gas chamber;
an anode porous base is a porous electronically-conductive structure and is
positioned adjacent to the current collector such that the current collector is positioned between the anode gas chamber and the anode porous base;
an anode catalyst layer comprising a conductive filler, a binder, and a catalyst, has an average porosity less than that of the anode porous base, and is positioned adjacent to the anode porous base such that the anode catalyst layer is positioned between the anode porous base and the anode-liquid interfacing layer; and
an anode-liquid interfacing layer comprising a porous polymer base and an ionomer coating configured to conduct protons through the anode-liquid interfacing layer, wherein the anode-liquid interfacing layer is positioned adjacent to the anode catalyst layer.
